(19) United States
(12) Patent Application Publication
(10) Pub. No.: US 2013/0278457 A1
(43) Pub. Date: Oct. 24, 2013

(54) DIRECTION DETECTION APPARATUS, DIRECTION DETECTION METHOD, AND DIRECTION DETECTION PROGRAM

(71) Applicant: HONDA ELESYS CO., LTD., Yokohama-shi (JP)

(72) Inventor: Hiroyuki KAMO, Yokohama-shi (JP)

(73) Assignee: Honda elesys Co., Ltd., Yokohama-shi (JP)

(21) Appl. No.: 13/868,826

(22) Filed: Apr. 23, 2013

(30) Foreign Application Priority Data
Apr. 23, 2012 (JP) 2012-097885

(51) Int. Cl. G01S 13/42

(52) U.S. Cl. CPC G01S 13/42
USPC 342/146

(57) ABSTRACT

A direction detection apparatus includes antennas of a plurality of systems having polarization characteristics different from each other and configured to receive a signal reflected by an object, a determination unit configured to determine the polarization characteristic of the received signal, and an operation processing unit configured to select a detection range corresponding to the polarization characteristic which have been determined.

### CROSS-REFERENCE TO RELATED APPLICATIONS

Priority is claimed on Japanese Patent Application No. 2012-097885, filed Apr. 23, 2012, the contents of which are entirely incorporated herein by reference.

### BACKGROUND OF THE INVENTION

1. Field of the Invention

The present invention relates to a direction detection apparatus, a direction detection method, and a direction detection program.

2. Description of Related Art

Recently, it has been proposed that safety of a vehicle in traveling is achieved using a direction detection apparatus detecting positions of a surrounding object. The direction detection apparatus includes multiple receiving elements so as to guarantee performance such as a viewing angle or a resolution.

For example, a radar apparatus described in Japanese Unexamined Patent Application, First Publication No. 2006-267016 (Patent Document 1) includes transmitting means for transmitting a transmission wave, N receiving means for receiving reflected waves of the transmission wave, sampling and holding means for sampling signals obtained by mixing a transmission signal of the transmission wave and reception signals of the reception waves at a predetermined timing and holding the sampled level in a predetermined period, A/D conversion means for sequentially converting the output of the sampling and holding means into digital signals, and a signal processor that determines the sampling timing and performs a digital beam forming process based on the output of the A/D conversion means.

### SUMMARY OF THE INVENTION

However, in the direction detection apparatus described in Patent Document 1, when the number of receiving means is set to a fixed number, the detection range in which a direction of an object can be detected is narrowed with an increase in detection accuracy. Therefore, it is necessary to perform different processes when the detection range is narrow but high detection accuracy is required and when the detection accuracy is low but a wide detection range is required. When both detection ranges are encompassed, an element for processing a reception signal should be provided for each detection range, thereby increasing the hardware size.

The present invention is made in consideration of the above-mentioned circumstances and an object thereof is to provide a direction detection apparatus, a direction detection method, and a direction detection program which do not increase the size of hardware.

(1) According to an aspect of the present invention, a direction detection apparatus is provided including: antennas of a plurality of systems having polarization characteristics different from each other and configured to receive signals reflected by an object; a determination unit configured to determine the polarization characteristics of the received signals; and an operation processing unit configured to select a detection range corresponding to the polarization characteristics which have been determined.

(2) In the direction detection apparatus, the operation processing unit may include a direction estimating unit configured to estimate a direction of the object using the received signals and a detection coefficient associated with the selected detection range.

(3) In the direction detection apparatus, the operation processing unit may be configured to repeatedly select the detection range when a predetermined time lapses after the detection coefficient is selected.

(4) According to another aspect of the present invention, a direction detection method is provided including the steps of receiving signals reflected by an object using antennas of a plurality of systems having polarization characteristics different from each other; determining the polarization characteristics of the received signals; and selecting a detection range corresponding to the polarization characteristics which have been determined.

(5) According to another aspect of the present invention, a direction detection program is provided causing a computer of a direction detection apparatus having antennas of a plurality of systems having polarization characteristics different from each other and configured to receive signals reflected by an object to perform the sequences of: determining the polarization characteristics of the received signals; and selecting a detection range corresponding to the polarization characteristics which have been determined.

According to the aspects of the present invention, it is possible to avoid an increase in the size of hardware.

### BRIEF DESCRIPTION OF THE DRAWINGS

FIG. 1 is a diagram schematically illustrating a configuration of a direction detection apparatus according to a first embodiment of the present invention.

FIG. 2 is a conceptual diagram illustrating an example of a detection range of each antenna system.

FIG. 3 is a diagram schematically illustrating an example of a configuration of an antenna system according to the first embodiment.

FIG. 4 is a diagram schematically illustrating an example of a configuration of a rat race circuit unit according to the first embodiment.

FIG. 5 is a diagram schematically illustrating configuration of a determination unit according to the first embodiment.

FIG. 6 is a cross-sectional view illustrating a cross-section taken along a longitudinal direction of a polarization separating unit according to the first embodiment.

FIG. 7 is a cross-sectional view illustrating a cross-section taken along a direction perpendicular to the longitudinal direction of the polarization separating unit according to the first embodiment.

FIG. 8 is a flowchart illustrating a process flow of determining a polarization component in the polarization separating unit according to the first embodiment.

FIG. 9 is a diagram schematically illustrating a configuration of an operation processing unit according to the first embodiment.

FIG. 10 is a flowchart illustrating a process flow of a direction detection process according to the first embodiment.

FIG. 11 is a conceptual diagram illustrating an example of a frequency variation of a transmission signal and a reception signal.

FIG. 12 is a diagram schematically illustrating a configuration of a direction detection apparatus according to a second embodiment of the present invention.

### DETAILED DESCRIPTION OF THE INVENTION

### First Embodiment

Hereinafter, a first embodiment of the present invention will be described referring to the accompanying drawings.

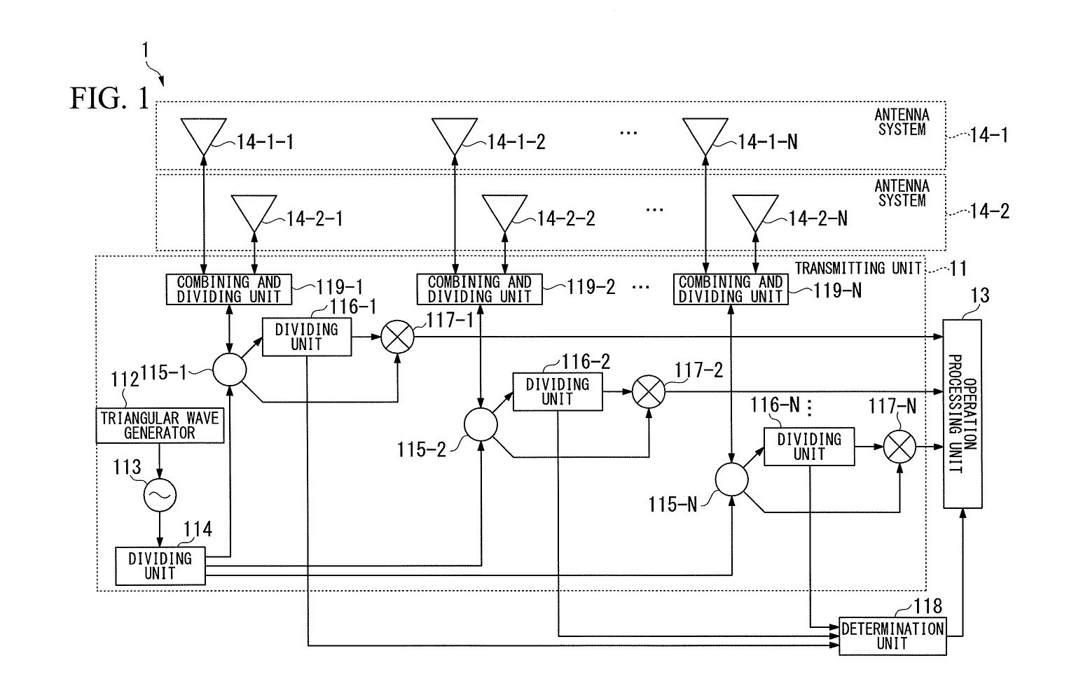

FIG. 1 is a diagram schematically illustrating a configuration of a direction detection apparatus 1 according to this embodiment.

The direction detection apparatus 1 includes a transmitting unit 11, a determination unit 118, an operation processing unit 13, and antenna systems 14-1 and 14-2.

The transmitting unit 11 includes a triangular wave generator 112, a VCO (Voltage-Controlled Oscillator) unit 113, a dividing unit 114, a rat race circuit units 115-1 to 115-N (where N is an integer larger than 1, for example, 6), dividing units 116-1 to 116-N, mixing units 117-1 to 117-N, and combining and dividing units 119-1 to 119-N.

The triangular wave generator 112 generates a triangular wave signal and outputs the generated triangular wave signal to the VCO unit 113.

The VCO unit 113 generates a sinusoidal signal of a predetermined central frequency and frequency-modulates the generated sinusoidal signal using the triangular wave signal input from the triangular wave generator 112 to generate a transmission signal.

The VCO unit 113 outputs the generated transmission signal (local signal) to the dividing unit 114.

The dividing unit 114 distributes and outputs the transmission signal input from the VCO unit 113 to the rat race circuit units 115-1 to 115-N. The dividing unit 114 includes, for example, a distributor.

The rat race circuit units 115-1 to 115-N output the transmission signal input from the dividing unit 114 to the mixing units 117-1 to 117-N and the combining and dividing units 119-1 to 119-N, respectively. The rat race circuit units 115-1 to 115-N output the reception signals input from the combining and dividing units 119-1 to 119-N to the dividing units 116-1 to 116-N, respectively. The configuration of the rat race circuit unit 115 will be described later.

The dividing units 116-1 to 116-N distribute and output the reception signals input from the rat race circuit units 115-1 to 115-N to the determination unit 118 and the mixing units 117-1 to 117-N, respectively.

The mixing units 117-1 to 117-N mix the transmission signal input from the rat race circuit units 115-1 to 115-N and the reception signals input from the dividing units 116-1 to 116-N for each channel and generates an IF signal (Intermediate Frequency signal) for each channel. The generated IF signal for each channel is a beat signal of which the amplitude oscillates with a difference frequency between the frequency of the transmission signal and the frequency of the reception signal of the corresponding channel. The mixing units 117-1 to 117-N output the generated IF signal to the operation processing unit 13.

The combining and dividing units 119-1 to 119-N distribute and output the transmission signal input from the rat race circuit units 115-1 to 115-N to the antenna units 14-1-1 to 14-1-N and the antenna units 14-2-1 to 14-2-N by channels. The combining and dividing units 119-1 to 119-N combine the reception signals input from the antenna units 14-1-1 to 14-1-N and the antenna units 14-2-1 to 14-2-N by channels and output the combined signal to the rat race circuit units 115-1 to 115-N. The combining and dividing units 119-1 to 119-N each include a combiner and a divider.

The determination unit 118 collects the reception signal input from the dividing units 116-1 to 116-N and determines to what antenna system the polarization characteristic of the collected reception signal corresponds. The correspondence between the polarization characteristics of the antenna systems will be described later. The determination unit 118 generates a determination signal indicating that the polarization component of the determined polarization characteristic is detected. The determination unit 118 outputs the generated determination signal to the operation processing unit 13. The configuration of the determination unit 118 will be described later.

The determination signal is input to the operation processing unit 13 from the determination unit 118. The operation processing unit 13 calculates position information of an object in the detection range of the antenna system corresponding to the determination signal based on the IF signals input from the mixing units 117-1 to 117-N. The configuration of the operation processing unit 13 will be described later.

The antenna systems 14-1 and 14-2 include the antenna units 14-1-1 to 14-1-N and the antenna units 14-2-1 to 14-2-N, respectively. The antenna units 14-1-1 to 14-1-N and the antenna units 14-2-1 to 14-2-N are antennas having both a transmitting function and a receiving function. That is, the antenna units 14-1-1 to 14-1-N and the antenna units 14-2-1 to 14-2-N radiate the transmission signal input from the combining and dividing units 119-1 to 119-N as radio waves and outputs received radio waves to the combining and dividing units 119-1 to 119-N as a reception signal. The polarization characteristics of the antenna units vary depending on the antenna systems. The configurations of the antenna system and the antenna unit and an example of the polarization characteristics will be described later.

In this embodiment, the antenna systems 14-1 and 14-2 have different detection ranges in which an object reflecting a signal is detected. An example of the detection range of each antenna system according to this embodiment will be described below.

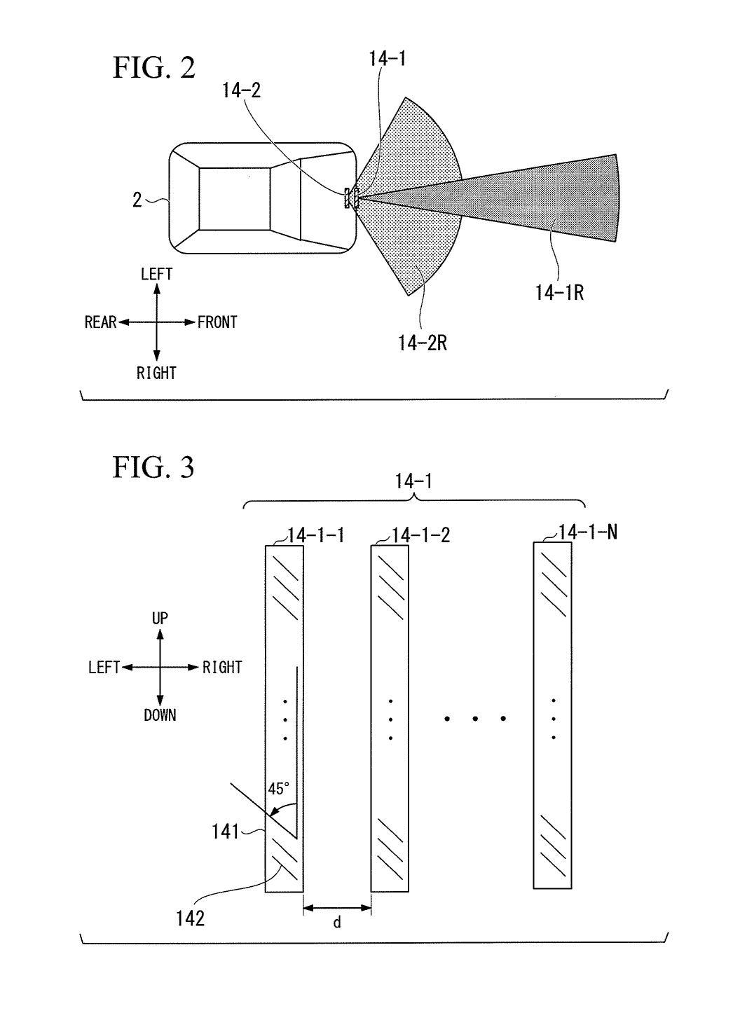

FIG. 2 is a conceptual diagram illustrating an example of the detection range of each antenna system.

FIG. 2 shows the entire top surface of a vehicle 2 on the left side of the center. In FIG. 2, the left-right direction indicates the longitudinal direction of the vehicle 2 and the up-down direction indicates the transverse direction of the vehicle 2.

The vehicle 2 includes antenna systems 14-1 and 14-2 at the center of the front surface.

The fan shape having a vertex at the antenna system 14-1 represents the detection range 14-1R of the antenna system 14-1, and the fan shape having a vertex at the antenna system 14-2 represents the detection range 14-2R of the antenna system 14-2. The detection range 14-1R covers a long distance (for example, several tens m, typically, about 200 m) remote from the antenna system 14-1 in the forward direction but is relatively narrow in the transverse direction (for example, 10° to left and right about the forward direction of the vehicle 2). The detection range 14-2R covers a short distance (for example, several m to several tens m) near the antenna system 14-1 in the forward direction but is relatively broad in the transverse direction (for example, 30° to 45° to left and right about the forward direction of the vehicle 2). In the following description, the detection range 14-1R is referred to as a long detection range and the detection range 14-2R is referred to as a short detection range.

The detection range of an antenna system can be enlarged or reduced, for example, by the use of an arrangement interval of the antenna units included in each antenna system. When the number of antenna units is fixed, the detection range becomes narrower and the radiation gain becomes higher with an increase in the arrangement interval. Accordingly, reception quality is superior. On the contrary, as the arrangement interval becomes smaller, the detection range becomes broader and the radiation gain becomes lower. Accordingly, the reception quality is inferior. In the example shown in FIG. 2, the antenna system 14-2 is smaller in arrangement interval of antennas than the antenna system 14-1. As a result, the antenna system 14-1 can estimate a direction of a detected object with higher accuracy than the antenna system 14-2.

For example, a known DBF (Digital Beam Forming) method is used as the process of estimating a direction of an object. In this embodiment, when the operation processing unit 13 uses the DBF method, the detection range or the direction accuracy of an object is changed by antenna systems. In this case, the arrangement interval of the antenna units is not necessarily changed. In the DBF method, spatial frequency component data is calculated for each target direction corresponding to the corresponding angular channel as described later. The target direction is determined every predetermined scanning pitch angle (which corresponds to the direction accuracy) in a predetermined detection range. In the DBF method, a target direction in which the spatial frequency component data is the maximum (peak) is defined as the direction of the object.

Here, the polarization characteristic of signals transmitted or received by the antenna units 14-1-1 to 14-1-N is different from the polarization characteristic of signals transmitted or received by the antenna units 14-2-1 to 14-2-N of the antenna system 14-2.

A polarized wave means a radio wave of which the electric field and the magnetic field oscillate only in a specific direction. A polarization characteristic means a direction in which the electric field and the magnetic field oscillate. The polarization characteristics of the transmission signal and the reception signal are constant in each antenna system, for example, in the antenna units 14-1-1 to 14-1-N. In the antenna units 14-2-1 to 14-2-N, the polarization characteristics of the transmission signal and the reception signal are constant. Hereinafter, the polarization characteristic of the antenna system 14-1 is referred to as a first polarization characteristic and the polarization characteristic of the antenna system 14-2 is referred to as a second polarization characteristic.

For example, the signals transmitted from the antenna units 14-1-1 to 14-1-N are 45° -polarized waves of which the electric field oscillates in a direction rotated by 45° in the counterclockwise direction about the vertical direction. That is, the first polarization characteristic is 45°-polarization. On the contrary, the signals transmitted from the antenna units 14-2-1 to 14-2-N are −45°-polarized waves of which the electric field oscillates in a direction rotated by 45° in the clockwise direction about the vertical direction. That is, the second polarization characteristic is −45°-polarization. In this way, the polarization plane of the transmission signal from the antenna system 14-1 is set to be perpendicular to the polarization plane of the transmission signal from the antenna system 14-2. The first polarization characteristic and the second polarization characteristic are not limited to this setting, but may be, for example, −45°-polarization and 45°-polarization, vertical polarization and horizontal polarization, or horizontal polarization and a vertical polarization, respectively. The horizontal polarization is a polarization characteristic in which the electric field oscillates in the horizontal direction parallel to the ground. The vertical polarization is a polarization characteristic in which the electric field oscillates in the vertical direction perpendicular to the ground.

An example of the configuration of the antenna system 14-1 according to this embodiment will be described below.

FIG. 3 is a diagram schematically illustrating an example of the configuration of the antenna system 14-1 according to this embodiment.

In FIG. 3, the antenna units 14-1-1 to 14-1-N each include a tube axis 141 extending in the up-down direction (vertical direction). The tube axes 141 are arranged on the same plane with an interval d from the neighboring tube axes 141 in the transverse direction. Each tube axis 141 includes slits 142 on the surface thereof in a direction rotated by 45° in the counterclockwise direction from the direction of the tube axis with a predetermined pitch. Accordingly, the antenna units 14-1-1 to 14-1-N transmit a transmission signal of a 45°-polarized wave in which the oscillation direction of the electric field is parallel to the slits 142, and receives a reception signal of a 45°-polarized wave reflected by an object.

The configuration of the antenna system 14-2 is the same as the configuration of the antenna system 14-1. The antenna units 14-2-1 to 14-2-N have the same structure as the antenna units 14-1-1 to 14-1-N, but have slits in a direction rotated by 45° in the clockwise direction from the direction of the tube axis. Accordingly, the antenna units 14-2-1 to 14-2-N transmit a transmission signal of a −45°-polarized wave in which the oscillation direction of the electric field is parallel to the slits, and receives a reception signal of a −45°-polarized wave reflected by an object.

As shown in FIG. 1, the reception signals received by the antenna units 14-1-1 to 14-1-N and the antenna units 14-2-1 to 14-2-N are input to the determination unit 118 through the combining and dividing units 119-1 to 119-N, the rat race circuit units 115-1 to 115-N, and the dividing units 116-1 to 116-N.

Therefore, the constituents are connected so that the difference between the polarization characteristics of the reception signals from the antenna systems, that is, between the first polarization characteristic and the second polarization characteristic. The antenna units 14-1-1 to 14-1-N, the antenna units 14-2-1 to 14-2-N, the combining and dividing units 119-1 to 119-N, the rat race circuit units 115-1 to 115-N, the dividing units 116-1 to 116-N, and the determination unit 118 are connected to each other with waveguides.

The configuration of the rat race circuit unit 115-1 will be described below.

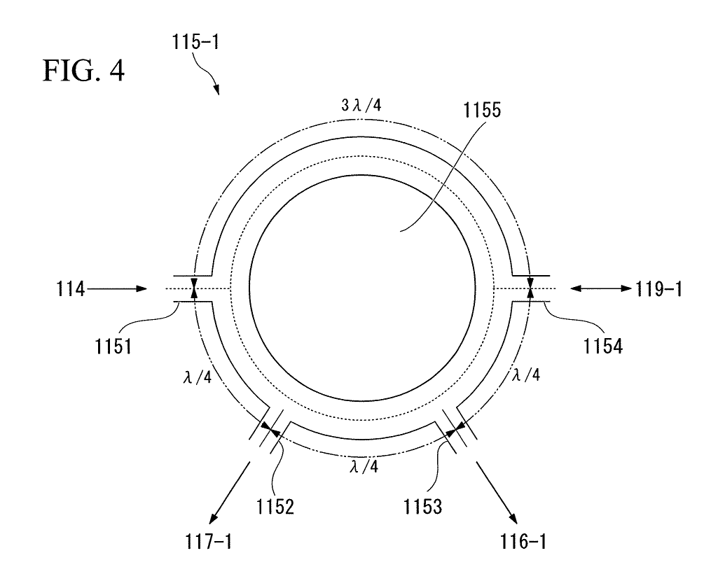

FIG. 4 is a diagram schematically illustrating the configuration of the rat race circuit unit 115-1 according to this embodiment.

The rat race circuit unit 115-1 includes an annular waveguide portion 1155. The tube path length of the waveguide portion 1155 is, for example, 3λ/2. The symbol λ represents a wavelength of a signal. Four ports 1151, 1152, 1153, and 1154 are opened on the outer circumference of the waveguide portion 1155. The port 1151 and the port 1154 are located on the opposite sides about the center of the waveguide portion 1155. The port 1152 and the port 1153 are located at points dividing the outer circumference of the waveguide portion 1155 between the port 1151 and the 1154 into three parts. Therefore, in the waveguide 1155, the path length from the port 1151 to the port 1154 is 3λ/4. The path length from the port 1151 to the port 1152, the path length from the port 1152 to the port 1153, and the path length from the port 1153 to the port 1154 are all λ/4. The ports 1151, 1152, 1153, and 1154 are connected to the dividing unit 114, the mixing units 117-1, the dividing unit 116-1, and the combining and dividing unit 119-1, respectively.

The transmission signal with a wavelength k input to the port 1151 from the dividing unit 114 travels in the clockwise direction and the counterclockwise direction in the waveguide portion 1155. Since the path length in the clockwise direction from the port 1151 to the port 1152 is 5λ/4 and the path length in the counterclockwise direction is λ/4, the difference in the path length therebetween is λ. Therefore, in the port 1152, the transmission signal traveling in the clockwise direction and the transmission signal traveling in the counterclockwise direction are reinforced and the reinforced transmission signal is output to the mixing units 117-1.

Since the path length in the clockwise direction from the port 1151 to the port 1153 is λ and the path length in the counterclockwise direction is λ/2, the difference in the path length therebetween is λ/2. Therefore, in the port 1153, the transmission signal traveling in the clockwise direction and the transmission signal traveling in the counterclockwise direction are cancelled and the transmission signal is not output to the dividing unit 116-1.

Since the path length in the clockwise direction from the port 1151 to the port 1154 is 3λ/4 and the path length in the counterclockwise direction is 3λ/4, the difference in the path length therebetween is 0. Therefore, in the port 1154, the transmission signal traveling in the clockwise direction and the transmission signal traveling in the counterclockwise direction are reinforced and the reinforced transmission signal is output to the combining and dividing unit 119-1.

On the other hand, the reception signal with a wavelength λ input to the port 1154 from the combining and dividing unit 119-1 travels in the clockwise direction and the counterclockwise direction in the waveguide portion 1155. Since the path length in the clockwise direction from the port 1154 to the port 1151 is 3λ/4 and the path length in the counterclockwise direction is 3λ/4, the difference in the path length therebetween is 0. Therefore, in the port 1151, the reception signal traveling in the clockwise direction and the reception signal traveling in the counterclockwise direction are reinforced and the reinforced reception signal is output to the dividing unit 114. Here, since the intensity of the reception signal output to the dividing unit 114 is much smaller than the intensity of the transmission signal, the influence on the transmission signal is small enough to be ignored.

Since the path length in the clockwise direction from the port 1154 to the port 1152 is λ/2 and the path length in the counterclockwise direction is λ, the difference in the path length therebetween is λ/2. Therefore, in the port 1152, the reception signal traveling in the clockwise direction and the reception signal traveling in the counterclockwise direction are cancelled and the reception signal is not output to the mixing units 117-1.

Since the path length in the clockwise direction from the port 1154 to the port 1153 is λ/4 and the path length in the counterclockwise direction is 5λ/4, the difference in the path length therebetween is λ. Therefore, in the port 1153, the reception signal traveling in the clockwise direction and the reception signal traveling in the counterclockwise direction are reinforced and the reinforced reception signal is output to the dividing unit 116-1.

The configurations of the rat race circuit units 115-2 to 115-N are the same as the configuration of the rat race circuit unit 115-1.

In this way, the rat race circuit units 115-1 to 115-N can separate the transmission signals transmitted and the reception signals received by the antenna units 14-1-1 to 14-1-N and the antenna units 14-2-1 to 14-2-N which are antennas having both a transmitting function and a receiving function.

The configuration of the determination unit 118 will be described below.

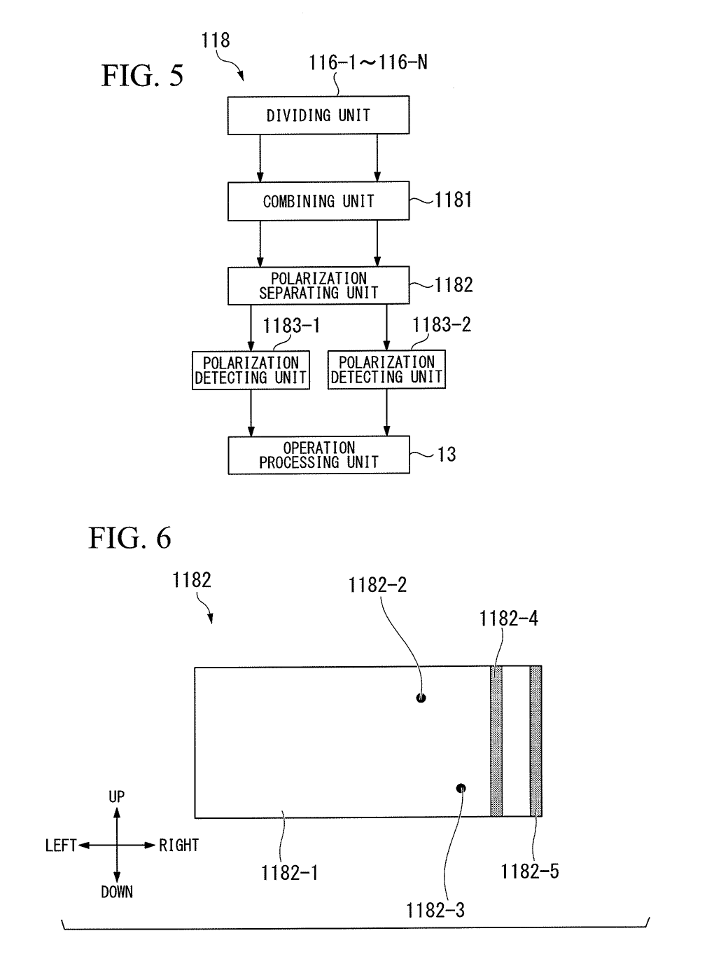

FIG. 5 is a diagram schematically illustrating the configuration of the determination unit 118 according to this embodiment.

The determination unit 118 includes a combining unit 1181, a polarization separating unit 1182, and polarization detecting units 1183-1 and 1183-2.

The combining unit 1181 combines the reception signals input from the dividing units 116-1 to 116-N and outputs the combined signal to the polarization separating unit 1182. The combining unit 1181 includes, for example, a combiner.

The polarization separating unit 1182 separates a first polarization component having the first polarization characteristic or a polarization characteristic based on the first polarization characteristic and a second polarization component having the second polarization characteristic or a polarization characteristic based on the second polarization characteristic from the signal input from the combining unit 1181. The polarization separating unit 1182 outputs the separated first polarization component to the polarization detecting unit 1183-1 and outputs the separated second polarization component to the polarization detecting unit 1183-2. The polarization separating unit 1182 includes, for example, a polarization separator (Ortho-Mode Transducer (OMT), also referred to as polarization divider).

The polarization detecting unit 1183-1 determines whether the first polarization component separated by the polarization separating unit 1182 is detected. The polarization detecting unit 1183-1 generates a determination signal indicating that the first polarization component is detected when the first polarization component is detected. The polarization detecting unit 1183-1 determines that the first polarization component is detected, for example, when the electric field intensity of the first polarization component is larger than a predetermined value. The polarization detecting unit 1183-1 outputs the generated determination signal to the operation processing unit 13.

The polarization detecting unit 1183-2 determines whether the second polarization component separated by the polarization separating unit 1182 is detected. The polarization detecting unit 1183-2 generates a determination signal indicating that the second polarization component is detected when the second polarization component is detected. The polarization detecting unit 1183-2 determines that the second polarization component is detected, for example, when the electric field intensity of the second polarization component is larger than a predetermined value. The polarization detecting unit 1183-2 outputs the generated determination signal to the operation processing unit 13.

A pickup type polarization separator will be described below as an example of the configuration of the polarization separating unit 1182.

FIG. 6 is a cross-sectional view illustrating a cross-section taken along the longitudinal direction of the polarization separating unit 1182 according to this embodiment.

The polarization separating unit 1182 includes a waveguide 1182-1, a first probe 1182-2, a second probe 1182-3, a first shorted plane 1182-4, and a second shorted plane 1182-5.

In FIG. 6, the left-right direction is the longitudinal direction of the polarization separating unit 1182. The signal input from the combining unit 1181 travels to the right.

In FIG. 6, the waveguide 1182-1 transmits a signal input from the combining unit 1181 to the first probe 1182-1, the second probe 1182-3, the first shorted plane 1182-4, and the second shorted plane 1182-5 and is terminated at the right end. The first probe 1182-2 and the second probe 1182-3 are disposed to extend toward the central axis through the outer wall from the outside of the waveguide 1182-1. The first probe 1182-2 and the second probe 1182-3 are disposed at different angles about the central axis of the waveguide 1182-1. This angle difference is based on the difference between the first polarization characteristic and the second polarization characteristic.

The first shorted plane 1182-4 is disposed to be separated by ¼ wavelength in the traveling direction of the signal from the first probe 1182-2, to be perpendicular to the central axis of the waveguide 1182-1, and to pass through the central axis thereof. The direction of the first shorted plane 1182-4 is the oscillation direction of the electric field corresponding to the first polarization characteristic. Accordingly, the first shorted plane 1182-4 reflects the first polarization characteristic.

The second shorted plane 1182-5 is disposed to be separated by ¼ wavelength in the traveling direction of the signal from the second probe 1182-3, to be perpendicular to the central axis of the waveguide 1182-1, and to pass through the central axis thereof. The direction of the second shorted plane 1182-5 is the oscillation direction of the electric field corresponding to the second polarization characteristic. Accordingly, the second shorted plane 1182-5 reflects the second polarization characteristic.

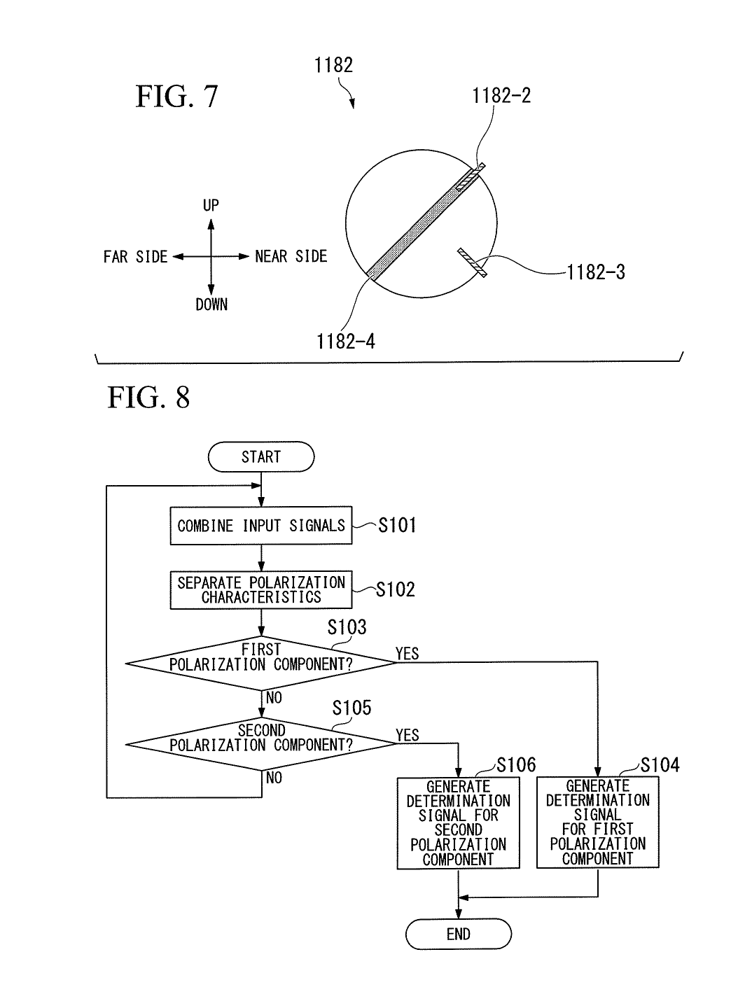

FIG. 7 is a cross-sectional view illustrating a cross-section taken along a direction perpendicular to the longitudinal direction of the polarization separating unit 1182 according to this embodiment.

In FIG. 7, the left-right direction indicates the depth direction.

In FIG. 7, the direction of the first shorted plane 1182-4 is equal to the direction of the first probe 1182-2 and different from the direction of the second probe 1182-3.

Accordingly, the first probe 1182-2 receives the first polarization component and outputs the received first polarization component to the polarization detecting unit 1183-1. The second probe 1182-3 receives the second polarization component and outputs the received second polarization component to the polarization detecting unit 1183-2.

A process flow of determining a polarization component in the polarization separating unit 1182 will be described below.

FIG. 8 is a flowchart illustrating the process flow of determining a polarization component in the polarization separating unit 1182 according to this embodiment.

(Step S101) The combining unit 1181 combines the reception signals input from the dividing units 116-1 to 116-N (input signal combination) and outputs the combined signal to the polarization separating unit 1182. Thereafter, the process flow goes to step S102.

(Step S102) The polarization separating unit 1182 separates the first polarization component and the second polarization component from the signal input from the combining unit 1181 (polarization characteristic separation). The polarization separating unit 1182 outputs the separated first polarization component to the polarization detecting unit 1183-1 and outputs the separated second polarization component to the polarization detecting unit 1183-2. Thereafter, the process flow goes to step S103.

(Step S103) The polarization detecting unit 1183-1 determines whether the first polarization component separated by the polarization separating unit 1182 is detected. When the first polarization component is detected (YES in step S103), the process flow goes to step S104. When the first polarization component is not detected (NO in step S103), the process flow goes to step S106.

(Step S104) The polarization detecting unit 1183-1 generates a determination signal indicating that the first polarization component is detected and outputs the generated determination signal to the operation processing unit 13. Thereafter, the process flow ends.

(Step S105) The polarization detecting unit 1183-2 determines whether the second polarization component separated by the polarization separating unit 1182 is detected. When the second polarization component is detected (YES in step S105), the process flow goes to step S105. When the second polarization component is not detected (NO in step S105), the process flow goes to step S101.

(Step S106) The polarization detecting unit 1183-2 generates a determination signal indicating that the second polarization component is detected and outputs the generated determination signal to the operation processing unit 13. Thereafter, the process flow ends.

The configuration of the operation processing unit 13 according to this embodiment will be described below.

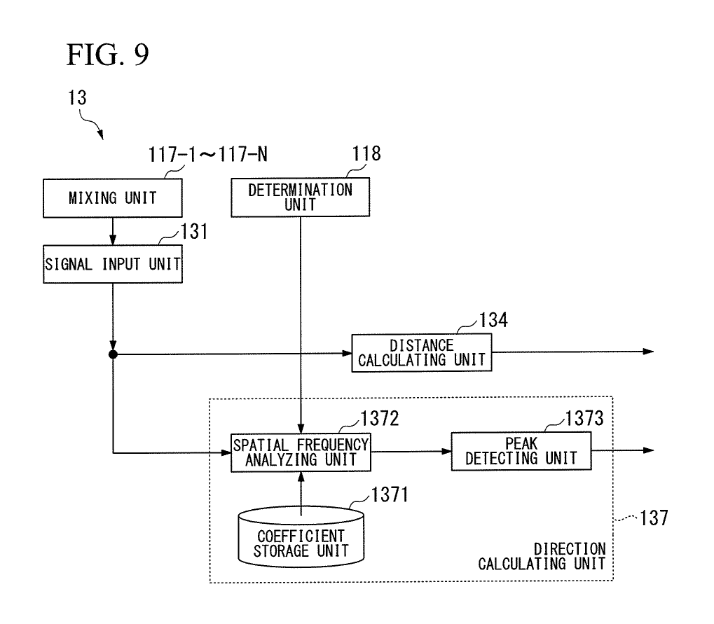

FIG. 9 is a diagram schematically illustrating the configuration of the operation processing unit 13 according to this embodiment.

The operation processing unit 13 includes a distance calculating unit 134 and a direction calculating unit (direction estimating unit) 137. The direction calculating unit 137 includes a coefficient storage unit 1371, a spatial frequency analyzing unit 1372, and a peak detecting unit 1373.

The IF signal of each channel is input to the signal input unit 131 from the mixing units 117-1 to 117-N.

The signal input unit 131 combines the input IF signals of the channels and outputs the combined IF signal to the distance calculating unit 134. The signal input unit 131 may output the IF signal of any channel to the distance calculating unit 134 instead of the combined IF signal. The signal input unit 131 outputs the input IF signals of the channels to the spatial frequency analyzing unit 1372.

The distance calculating unit 134 detects the frequencies of the IF signals input from the signal input unit 131. The frequency of the IF signal periodically varies as described later. The distance calculating unit 134 detects an ascent frequency fᵣₐ of a portion in which the frequencies of the transmission signal and the reception signal ascend and a descent frequency f_{rd} of a portion in which the frequencies of the transmission signal and the reception signal descend. The distance calculating unit 134 calculates an estimated value (estimated distance value) R of the distance to an object based on the detected ascent frequency fᵣₐ and the detected descent frequency f_{rd}, for example, suing Equation 1.

$$R = \frac{c ( {f}_{r d} + {f}_{ra} )}{4 Δ f \cdot {f}_{m}} \qquad ( 1 )$$

In Equation 1, Δf represents the frequency modulation width of a transmission signal, fₘ represents the frequency of a triangular wave, and c represents the speed of light.

An example of the frequency variation of the transmission signal and the reception signal which are bases of the IF signal will be described later.

The distance calculating unit 134 outputs the calculated estimated distance value R to the outside.

The coefficient storage unit 1371 stores direction estimation coefficients in advance in correlation with detection range information indicating the detection range of each antenna system. The direction estimation coefficient is, for example, a directivity characteristic coefficient representing a directivity characteristic based on the antenna arrangement of the antenna system corresponding to the detection range information in the frequency domain.

For example, the directivity characteristic coefficient corresponding to the long detection range may be a coefficient representing the directivity characteristic based on the arrangement of the antenna units 14-1-1 to 14-1-N of the antenna system 14-1. The directivity characteristic coefficient corresponding to the short detection range may be a coefficient representing the directivity characteristic based on the arrangement of the antenna units 14-2-1 to 14-2-N of the antenna system 14-2. The angle resolution expressed by the sharpness of the peak of the directivity characteristic is raised, for example, as the antenna pitch of each antenna system becomes larger. Therefore, the antenna system 14-1 having a larger antenna pitch is higher in angle resolution than the antenna system 14-2.

The direction estimation coefficient stored in the coefficient storage unit 1371 may be, for example, the detection range and the scanning pitch angle used in the DBF method. Here, the detection range (for example, 5°) and the scanning pitch angle (for example, 0.1°) corresponding to the long detection range are smaller than the detection range (for example, 60°) and the scanning pitch angle (for example, 1°) corresponding to the short detection range.

The spatial frequency analyzing unit 1372 determines that the detection range of the antenna system associated with the polarization component indicated by the determination signal input from the determination unit 118 and reads the direction estimation coefficient corresponding to the determined detection range from the coefficient storage unit 1371.

The spatial frequency analyzing unit 1372 Fourier-transforms the IF signal input from the signal input unit 131 in the time axis direction to calculate frequency-domain data. When the read direction estimation coefficient is the directivity characteristic coefficient, the spatial frequency analyzing unit 1372 multiplies the read direction estimation coefficient by the calculated frequency-domain data for each frequency to Fourier-transform the data in the arrangement direction of the antennas corresponding to each channel, whereby spatial axis data is calculated.

The spatial frequency analyzing unit 1372 calculates the spatial frequency component data for each angle channel within a predetermined angle range with a predetermined angle resolution based on the calculated spatial axis data. Here, when the read direction estimation coefficient indicates the detection range and the scanning pitch angle, the spatial frequency analyzing unit 1372 calculates the spatial frequency component data for each angle channel within the read angle range using the read scanning pitch angle as the angle resolution based on the spatial axis data.

The spatial frequency analyzing unit 1372 outputs the calculated spatial frequency component data to the peak detecting unit 1373.

The peak detecting unit 1373 detects the peak of the spatial frequency component data input from the spatial frequency analyzing unit 1372. The peak detecting unit 1373 generates direction information indicating the angle corresponding to the detected peak and outputs the generated direction information to the outside. The direction information represents the direction of an object reflecting the transmission signal.

A direction detecting process according to this embodiment will be described below.

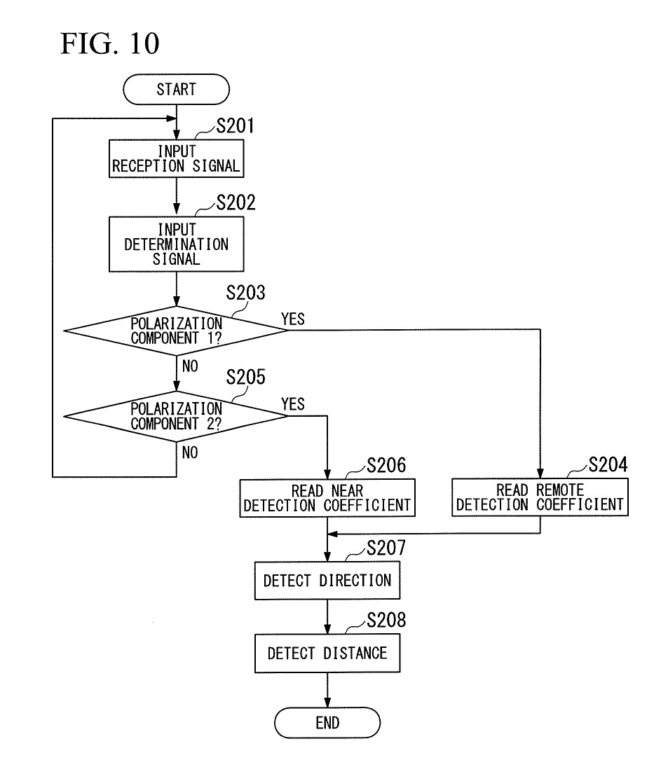

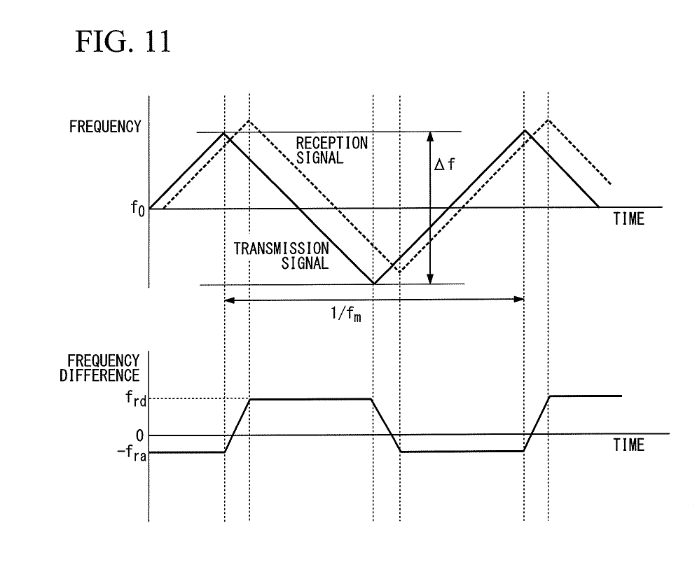

FIG. 10 is a flowchart illustrating the process flow of the direction detecting process according to this embodiment.

(Step S201) The signal input unit 131 outputs the IF signals of the channels input from the mixing units 117-1 to 117-N to the spatial frequency analyzing unit 1372. The signal input unit 131 combines the input IF signals of the channels and outputs the combined IF signal to the distance calculating unit 134. Thereafter, the process flow goes to step 5202.

(Step S202) The determination signal is input to the spatial frequency analyzing unit 1372 from the determination unit 118. Thereafter, the process flow goes to step S203.

(Step S203) The spatial frequency analyzing unit 1372 determines whether the input determination signal indicates the first polarization component. When it is determined that the determination signal indicates the first polarization component (polarization component 1) (YES in step S203), the process flow goes to step S204. When it is determined that the determination signal does not indicate the first polarization component (NO in step S203), the process flow goes to step S205.

(Step S204) The spatial frequency analyzing unit 1372 reads the direction estimation coefficient corresponding to the long detection range 14-1R of the antenna system 14-1 associated with the first polarization component from the coefficient storage unit 1371 (reading of remote detection coefficient). Thereafter, the process flow goes to step S207.

(Step S205) The spatial frequency analyzing unit 1372 determines whether the input determination signal indicates the second polarization component. When it is determined that the determination signal indicates the second polarization component (polarization component 2) (YES in step S205), the process flow goes to step S206. When it is determined that the determination signal does not indicate the second polarization component (NO in step S205), the process flow goes to step S201.

(Step S206) The spatial frequency analyzing unit 1372 reads the direction estimation coefficient corresponding to the short detection range 14-2R of the antenna system 14-2 associated with the second polarization component from the coefficient storage unit 1371 (reading of near detection coefficient). Thereafter, the process flow goes to step S207.

(Step S207) The spatial frequency analyzing unit 1372 Fourier-transforms the IF signal input from the signal input unit 131 to the time axis to calculate the frequency-domain data. The spatial frequency analyzing unit 1372 calculates the spatial frequency component data for each channel based on the calculated frequency-domain data and the read direction estimation coefficient, and outputs the calculated spatial frequency component data to the peak detecting unit 1373 for each modulation frequency.

The peak detecting unit 1373 detects the peak of the spatial frequency component data input from the spatial frequency analyzing unit 1372 (detection of direction). The peak detecting unit 1373 generates direction information indicating the angle corresponding to the detected peak and outputs the generated direction information to the outside. Thereafter, the process flow goes to step S208.

(Step S208) The distance calculating unit 134 detects the frequency of the IF signal input from the signal input unit 131. The distance calculating unit 134 calculates the estimated distance value R to an object based on the detected ascent frequency fᵣₐ and the detected descent frequency f_{rd}, for example, using Equation 1 (detection of distance). The distance calculating unit 134 outputs the calculated estimated distance value R to the outside. Thereafter, the process flow ends.

When this process flow is repeated after the direction detecting process ends, the distance calculating unit 134 and the direction calculating unit 137 may wait for a predetermined time (for example, the modulation period of the transmission signal or a multiple period thereof). This is intended to exclude arrival waves or multipath signals from the outside of the detection range 14-1R (long detection range) having a delay larger than a predetermined time. The multipath signal is an arrival wave propagating in various paths based on structures such as walls on a road or other vehicles from a signal source. By excluding these arrival waves, the arrival direction θ of the arrival wave from an object located in a predetermined detection area can be estimated with high accuracy.

An example of the frequency variation of a transmission signal and a reception signal will be described below.

FIG. 11 is a conceptual diagram illustrating an example of a frequency variation of a transmission signal and a reception signal.

The upper part of FIG. 11 shows the temporal variation of the frequencies of a transmission signal and a reception signal. In the upper part of FIG. 11, the horizontal axis represents the time and the vertical axis represents the frequency. The origin of the vertical axis is the central frequency f₀ of the transmission signal.

The frequency of the transmission signal is modulated about the central frequency f₀ with a period of 1/fₘ and with a frequency modulation width Δf. In the upper part of FIG. 11, the frequency of the transmission signal ascends in the first ¼ period of the first period, the frequency descends in the next ½ period, and the frequency ascends in the final ¼ period.

The frequency of the reception signal is modulated with the frequency modulation width Δf and with the period of 1/fₘ, but the central frequency thereof is different from that of the transmission signal, in that the reception signal is delayed from the transmission signal and there is a relative speed difference between the observation point and the reflection point. Accordingly, a frequency difference is generated between the transmission signal and the reception signal.

The lower part of FIG. 11 shows the temporal variation of the frequency difference between a transmission signal and a reception signal. In the lower part of FIG. 11, the horizontal axis represents the time and the vertical axis represents the frequency.

The frequency difference is modulated with the period of 1/fₘ and with the minimum frequency of −fᵣₐ and a maximum frequency of f_{rd}. The time area in which the minimum frequency −fᵣₐ is taken is a portion (ascent portion) in which both frequencies of the reception signal and the transmission signal ascend. The time area in which the maximum frequency f_{rd} is taken is a portion (descent portion) in which both the frequencies of the reception signal and the transmission signal descend.

The frequency of the amplitude of the IF signal is the absolute value of the frequency difference between the transmission signal and the reception signal. Therefore, the distance calculating unit 134 can detect the frequency of the amplitude of the IF signal in the ascent portion as the ascent frequency fᵣₐ, and can detect the frequency of the amplitude of the IF signal in the descent portion as the descent frequency f_{rd}. The distance calculating unit 134 can calculate the estimated distance value R to an object based on the detected ascent frequency fᵣₐ and the detected descent frequency f_{rd}, for example, using Equation 1.

In this way, this embodiment includes antennas of multiple systems receiving a signal reflected by an object and having different polarization characteristics and a determination unit determining the polarization characteristic of the received signal. This embodiment further includes an operation processing unit selecting the detection coefficient of the detection range corresponding to the determined polarization characteristic. Accordingly, since a configuration for detecting a direction does not need to be provided for each antenna system or each detection range, the size of the hardware is not increased. Since the elements or processors processing microwaves are expensive, this embodiment can achieve a decrease in cost.

### Second Embodiment

A second embodiment of the present invention will be described below. The configurations and processes common to the first embodiment will be referenced by the same reference signs and differences from the first embodiment will be mainly described below. A direction detection apparatus 10 according to this embodiment does not employ antenna units having both a transmitting function and a receiving function, but includes a transmitting antenna unit transmitting a transmission signal and multiple receiving antenna systems having receiving antenna units receiving reception signals. In this embodiment, the polarization characteristic differs depending on the receiving antenna systems.

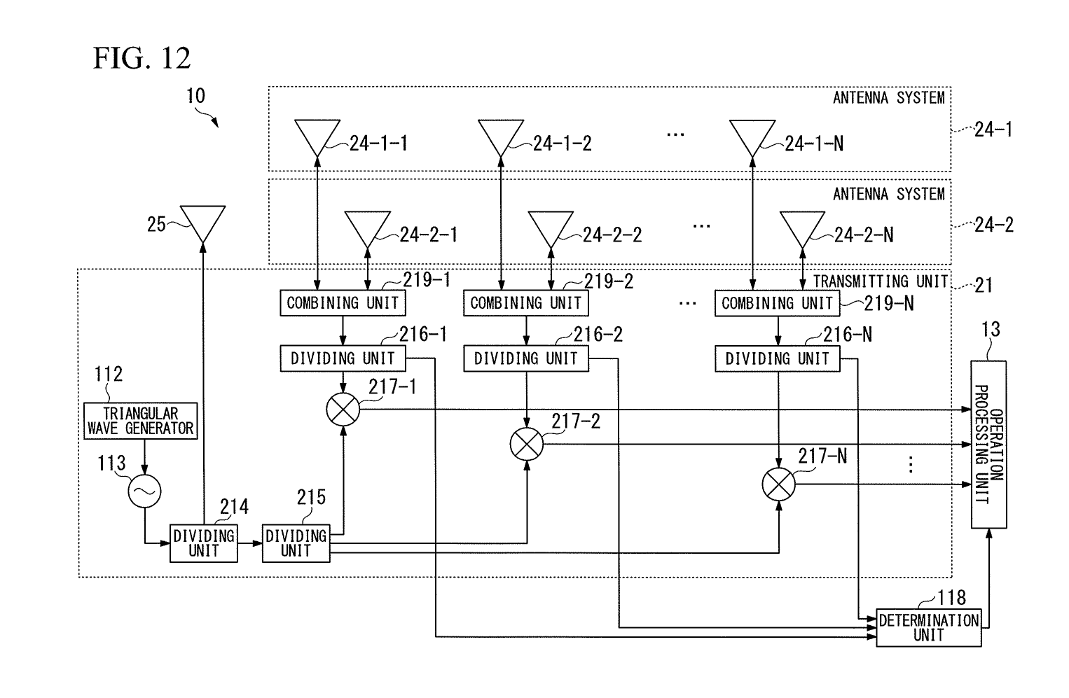

FIG. 12 is a diagram schematically illustrating the configuration of the direction detection apparatus 10 according to this embodiment.

The direction detection apparatus 10 includes a transmitting unit 21, antenna systems 24-1 and 24-2, an antenna unit 25, a determination unit 118, and an operation processing unit 13.

The transmitting unit 21 includes a triangular wave generator 112, a VCO unit 113, dividing units 214, 215, and 216-1 to 216-N, mixing units 217-1 to 217-N, and combining units 219-1 to 219-N.

The dividing unit 214 outputs the transmission signal input from the VCO unit 113 to the antenna unit 25 and the dividing unit 215.

The dividing unit 215 outputs the transmission signal input from the dividing unit 214 to the mixing units 217-1 to 217-N.

The dividing units 216-1 to 216-N distribute and output the reception signals input from the combining units 219-1 to 219-N to the mixing units 217-1 to 217-N and the determination unit 118.

The mixing units 217-1 to 217-N mix the transmission signal input from the dividing unit 215 and the reception signals input from the dividing units 216-1 to 216-N and generate an IF signal for each channel. The mixing units 217-1 to 217-N output the generated IF signals to the operation processing unit 13.

The combining units 219-1 to 219-N combine the reception signals input from the antenna units 24-1-1 to 24-1-N and the reception signals input from the antenna units 24-2-1 to 24-2-N for each channel and output the combined reception signals to the dividing units 216-1 to 216-N.

The determination unit 118 generates a determination signal based on the reception signals input from the dividing units 216-1 to 216-N and output the generated determination signal to the operation processing unit 13.

The operation processing unit 13 calculates position information of an object within a detection range of the antenna system corresponding to the determination signal input from the determination unit 118 based on the IF signals input from the mixing units 217-1 to 217-N.

The antenna unit 25 is a transmitting antenna transmitting the transmission signal input from the dividing unit 214 as radio waves. The polarization characteristic of the transmission signal transmitted from the antenna unit 25 is, for example, horizontal polarization or vertical polarization.

The antenna systems 24-1 and 24-2 include N antenna units 24-1-1 to 24-1-N and N antenna units 24-2-1 to 24-2-N, respectively.

The antenna units 24-1-1 to 24-1-N and the antenna units 24-2-1 to 24-2-N are reception-dedicated antennas outputting the reception signals received as radio waves to the combining units 219-1 to 219-N. The antenna units 24-1-1 to 24-1-N and the antenna units 24-2-1 to 24-2-N have the same configurations as the antenna units 14-1-1 to 14-1-N and the antenna units 14-2-1 to 14-2-N.

The polarization characteristics of the antenna systems 24-1 and 24-2 are different from each other. For example, the polarization characteristics of the antenna systems 24-1 and 24-2 are 45°-polarization and −45°-polarization, respectively. In this way, the polarization directions of the antenna systems 24-1 and 24-2 are perpendicular to each other, and the polarization characteristic of the combined signal of the signals having the polarization characteristics is set to the same as the polarization characteristic of the antenna unit 25.

The combination of the polarization characteristics of the antenna systems 24-1 and 24-2 and the antenna unit 25 may be different from the above-mentioned example. The combination of the polarization characteristics of the antenna systems 24-1 and 24-2 and the antenna unit 25 may be, for example, any one of (I) vertical polarization (0°-polarization), horizontal polarization (90°-polarization), and 45°-polarization, (II) 45°-polarization, −45°-polarization, and vertical polarization, (III) 45°-polarization, 135°-polarization, and horizontal polarization, (IV) vertical polarization, horizontal polarization, and circular polarization, and (V) 45°-polarization, −45°-polarization, and vertical polarization. The polarization characteristic of the antenna system 24-1 and the polarization characteristic of the antenna system 24-2 may be opposite to the above-mentioned examples.

Accordingly, even if the number of antenna units 25 is one, the antenna systems can receive reception signals having the corresponding polarization characteristics. In this case, the determination unit 118 determines the polarization characteristic of a reception signal and the operation processing unit 13 performs the direction detecting process in the detection range corresponding to the determined polarization characteristic.

Therefore, in this embodiment, similarly to the first embodiment, it is possible to reduce the size of the hardware and the cost. In this embodiment, since the antenna units are independently used each other for transmission of a transmission signal and reception of a reception signal, the configurations (for example, the rat race circuit units 115-1 to 115-N) for separating the transmission signal and the reception signal from each other can be made to be unnecessary.

The example where the number of detection range candidates is two is described above, but the present invention is not limited to this example. In the above-mentioned embodiment, the number of detection range candidates (the number of antenna systems) may be an integer larger than two, for example, three.

The example where the direction calculating unit 137 performs the spatial frequency analysis and the peak detection to estimate a direction of an object is described above, but the present invention is not limited to this example. In the above-mentioned embodiment, known methods such as a Capon method, a Burg method, a modified covariance method, an ESPRIT method, a MUSIC method, an SAGE method, a MODE method, an IQML method, and an EM-ML method may be used to calculate a direction. The operation processing unit 13 may have the same configuration as a signal processor of an electronic scanning radar apparatus described in Japanese Unexamined Patent Application, First Publication No. 2011-117896.

The example where the polarization separating unit 1182 includes a pickup type polarization separator is described above, but the present invention is not limited to this example. In the above-mentioned embodiments, the polarization separating unit may include a waveguide type, a branch line type, or other types of polarization separators, as long as it can separate or detect polarization components having the polarization characteristics by the antenna systems.

A part of the direction detection apparatuses 1 and 10 in the above-described embodiments, for example, the distance calculating unit 134, the spatial frequency analyzing unit 1372, and the peak detecting unit 13 may be realized by a computer. In this case, a program for realizing the control function may be recorded on a computer-readable recording medium, and the program recorded on the recording medium may be read by a computer system for execution. Here, the “computer system” may be a computer system built in the direction detection apparatuses 1 and 10, and may include hardware such as an OS or peripherals.

Furthermore, the “computer-readable recording medium” refers to a removable medium such as a flexible disk, a magneto-optical disc, a ROM or a CD-ROM, or a storage device such as a hard disk built in the computer system. Furthermore, the “computer-readable recording medium” may include a medium that dynamically stores a program for a short time, such as a communication cable in a case where the program is transmitted through a network such as the internet or a communication line such as a telephone line, or a medium that stores, in this case, the program for a specific time, such as a volatile memory inside a computer system including a server and a client. Furthermore, the program may be a program that realizes a part of the above-described functions, or may be a program that realizes the above-described functions by combination with a program that is recorded in advance in the computer system.

Furthermore, a part or all of the direction detection apparatuses 1 and 10 according to the above-described embodiments may be realized as an integrated circuit such as an LSI (Large Scale Integrated) circuit. The respective function blocks of the direction detection apparatuses 1 and 2 may be individually realized as a processor, or a part or all thereof may be integrated into a processor. Furthermore, a method of implementing the integration circuit is not limited to the LSI, and may be realized as a dedicated circuit or a general purpose processor. Furthermore, in a case where an integration circuit technique as a replacement for the LSI appears according to technological advances, an integration circuit according to the technique may be used.

As described above, the embodiments of the invention have been described in detail with reference to the accompanying drawings, but a specific configuration is not limited to the above description, and various design changes may be made in a range without departing from the spirit of the invention.

What is claimed is:

1. A direction detection apparatus comprising:
antennas of a plurality of systems having polarization characteristics different from each other and configured to receive signals reflected by an object;
a determination unit configured to determine the polarization characteristics of the received signals; and
an operation processing unit configured to select a detection range corresponding to the polarization characteristics which have been determined.

2. The direction detection apparatus according to claim 1, wherein the operation processing unit comprises a direction estimating unit configured to estimate a direction of the object using the received signals and a detection coefficient associated with the selected detection range.

3. The direction detection apparatus according to claim 2, wherein the operation processing unit configured to repeatedly select the detection range when a predetermined time lapses after the detection coefficient is selected.

4. A direction detection method comprising the steps of:
receiving signals reflected by an object using antennas of a plurality of systems having polarization characteristics different from each other;
determining the polarization characteristics of the received signals; and
selecting a detection range corresponding to the polarization characteristics which have been determined.

5. A direction detection program causing a computer of a direction detection apparatus having antennas of a plurality of systems having polarization characteristics different from each other and configured to receive signals reflected by an object to perform the sequences of:
determining the polarization characteristics of the received signals; and
selecting a detection range corresponding to the polarization characteristics which have been determined.
